(19) United States
(12) Patent Application Publication
(10) Pub. No.: US 2010/0009697 A1
(43) Pub. Date: Jan. 14, 2010

(54) MOBILE COMMUNICATION DEVICE CAPABLE OF SELF-REPORTING LOCATION AND METHOD THEREOF

(75) Inventor: KIM-YEUNG SIP, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/494,195

(22) Filed: Jun. 29, 2009

(30) Foreign Application Priority Data
Jul. 8, 2008 (CN) 200810302651.0

(51) Int. Cl. H04W 64/00; H04M 1/00

(52) U.S. Cl. 455/456.1; 455/572; 455/556.1

(57) ABSTRACT

A mobile communication device includes a power management module, a central processing module, a positioning module, a communication module, and a self-startup control module. The power management module stops providing power for the mobile communication device except for the communication module and the self-startup control module, when the mobile communication device is shut down. The self-startup control module stores reference information. When the communication module receives a radio signal indicating feature information matches the reference information, the self-startup control module produces a first startup signal and a second startup signal. The power management module distributes the power to the central processing module and the positioning module when receiving the first startup signal. The positioning module produces location information when receiving the second startup signal. The central processing module controls the communication module to send the location information to a mobile service center.

### BACKGROUND

1. Technical Field

The disclosure relates to electronic devices and, particularly, to a mobile communication device and a method for the device to report its location.

2. Description of Related Art

Mobile communication devices are easily lost or stolen because of their small size and portability. A method to find lost mobile communication devices is to preset a phone number in a mobile communication device by the owner of the mobile communication device. If the mobile communication device is lost, and a person who picks up the mobile communication device changes a subscriber identity module (SIM) card of the mobile communication device, the mobile communication device will automatically dial the preset phone number to alert the owner, so that the owner can find the mobile communication device easily.

However, if the mobile communication device has been shut down, the above method is ineffective.

Therefore, it is necessary to provide an electronic device and a method to overcome the above-identified deficiency.

### BRIEF DESCRIPTION OF THE DRAWINGS

The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a mobile communication device.

FIG. 2 is a flowchart illustrating an embodiment of a method for reporting a location of a mobile communication device.

### DETAILED DESCRIPTION

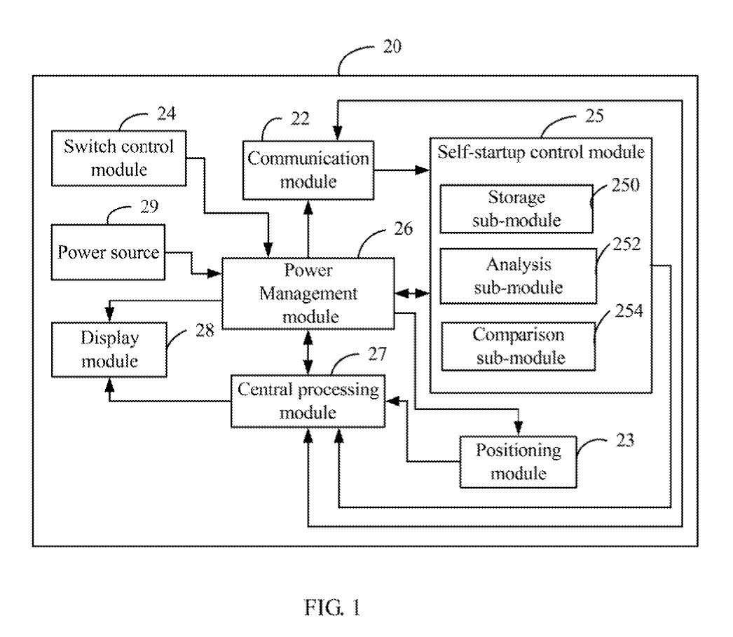

Referring to FIG. 1, a block diagram of a mobile communication device 20 is shown. The mobile communication device 20 is designed to report its position/location information when receiving a radio signal which includes feature information matching reference information stored in the mobile communication device 20. The mobile communication device 20 includes a communication module 22, a positioning module 23, a switch control module 24, a self-startup control module 25, a power management module 26, a central processing module 27, a display module 28, and a power source 29.

The communication module 22 is configured for connecting the mobile communication device 20 to one or more other electronic devices via a communication network. For example, the communication module 22 is capable of receiving radio signals from a mobile service center.

The positioning module 23 is configured for producing location information of the mobile communication device 20. In one embodiment, the positioning module 23 sends a positioning request to a global positioning system (GPS) or a global navigation satellite system (GNSS), and produces location information of the mobile communication device 20 by obtaining positioning signals fed back by the GPS or the GNSS. The switch control module 24 is configured for producing a power-off signal in response to user operations. In one embodiment, the switch control module 24 is a power switch which produces power-off signals when being depressed by the user. The power management module 26 is configured for distributing power from the power source 29 to a plurality of functional components of the mobile communication device 20. In one embodiment, when the power management module 26 receives the power-off signal, the power management module 26 discontinues the power from the power source 29 to the positioning module 23, the central processing module 27, and the display module 28, but continues supplying power to the communication module 22 and the self-startup control module 25.

The self-startup control module 25 is configured for storing reference information. In one embodiment, the reference information may be an international mobile subscriber identification number (IMSI) or an international mobile equipment identity (IMEI). The self-startup control module 25 is also configured for producing a first startup signal and a second startup signal when the radio signal received by the communication module 22 includes feature information that matches the reference information.

The self-startup control module 25 includes a storage sub-module 250, an analysis sub-module 252, and a comparison sub-module 254. The storage sub-module 250 is configured for storing the reference information. The analysis sub-module 252 is configured for analyzing the received radio signal and obtains feature information of the received radio signal. The comparison sub-module 254 is configured for comparing the feature information with the reference information, and producing a first startup signal and a second startup signal when the feature information matches the reference information.

In one embodiment, the power management module 26 resumes distributing power from the power source 29 to the positioning module 23 and the central processing module 27 when receiving the first startup signal. The positioning module 23 produces location information of the mobile communication device 20 when receiving the second startup signal, and the central processing module 27 controls the communication module 22 to transmit the location information to the mobile service center. As described above, the positioning module 23 sends the positioning request to the GPS or the GNSS, and produces the location information according to the positioning signals fed back by the GPS or the GNSS.

Therefore, if the mobile communication device 20 is lost or stolen and has been shut down, the power management module 26 still provides power to the communication module 22 and the self-startup control module 25. The user who loses the mobile communication device 20 can send radio signals including feature information (e.g., IMSI or IMEI) that matches the reference information stored in the mobile communication device 20 to the mobile communication device 20 via the mobile service center. For example, the user calls the mobile service center and provides the IMSI or IMEI to the mobile service center. The mobile service center then sends radio signals carrying the IMSI or the IMEI to the mobile communication device 20. The mobile communication device 20 is started up automatically and the positioning module 23 sends the location information of the mobile communication device 20 to the mobile service center, so that the user is able to find the mobile communication device 20.

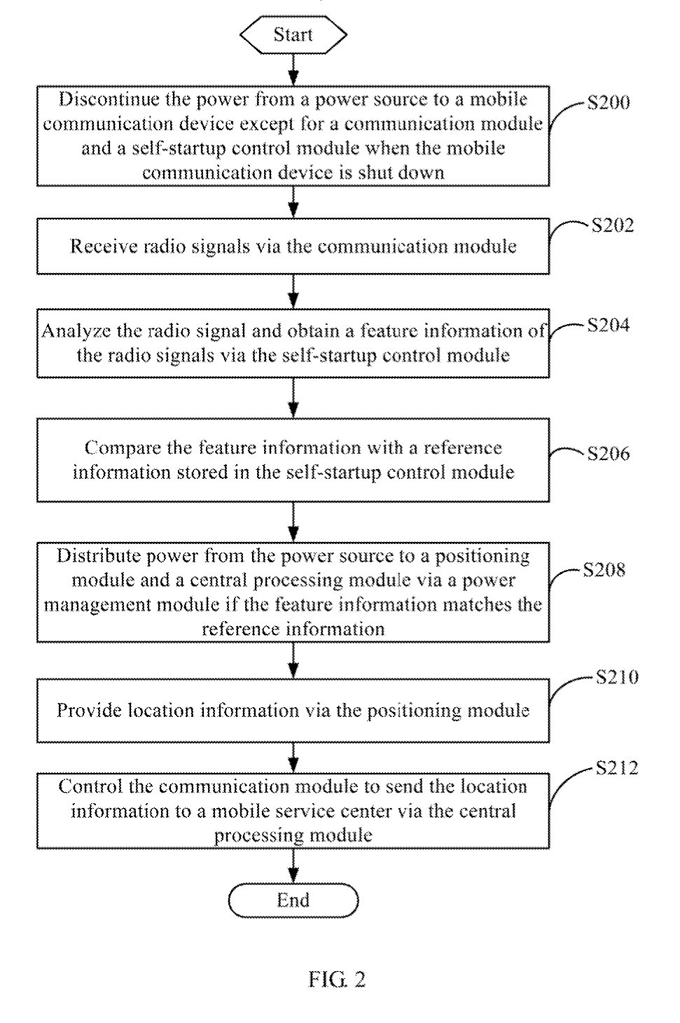

FIG. 2 is a flowchart illustrating an embodiment of a method for reporting the location of a mobile communication device 20. Depending on the embodiment, certain of the steps described below may be removed, others may be added, and the sequence of steps may be altered. It is also to be understood that the above description and the claims drawn to a method may include some indication in reference to certain steps. However, the indication used is only to be viewed for identification purposes and not as a suggestion as to an order for the steps.

In step S200, the power management module 26 discontinues distributing power from the power source 29 to the mobile communication device 20 except for the communication module 22 and the self-startup control module 25 when receiving a power-off signal.

In step S202, the communication module 22 receives radio signals from a mobile service center.

In step S204, the analysis sub-module 252 analyzes the radio signals and obtains feature information of the radio signals.

In step S206, the comparison sub-module 254 compares the feature information with reference information stored in the storage sub-module 250.

If the comparison sub-module 254 determines the feature information matches the reference information, in step S208, the comparison sub-module 254 produces a first startup signal and a second startup signal, and the power management module 26 distributes power from the power source 29 to the positioning module 23 and the central processing module 27 upon receiving the first startup signal.

In step S210, the positioning module 23 provides location information of the mobile communication device 20 upon receiving the second startup signal.

In step S212, the central processing module 27 controls the communication module 22 to send the location information to the mobile service center, so that the user of the mobile communication device 20 is capable of finding the mobile communication device 20 according to the location information.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A mobile communication device, comprising:
a communication module connecting the mobile communication device to other electronic devices via a communication network;
a switch control module producing a power-off signal in response to user operations;
a self-startup control module producing a first startup signal and a second startup signal when a radio signal received by the communication module indicates feature information matches pre-stored reference information;
a positioning module;
a central processing module; and
a power management module discontinuing power from a power source to the mobile communication device upon receiving the power-off signal, except for the communication module and the self-startup control module, and distributing the power to the positioning module and the central processing module when receiving the first startup signal, wherein the positioning module produces location information of the mobile communication device when receiving the second startup signal and the central processing module controls the communication module to send the location information to a mobile service center.

2. The mobile communication device of claim 1, wherein the self-startup control module comprises a storage sub-module storing the reference information, an analysis sub-module analyzing the radio signals and obtaining the feature information from the radio signal, and a comparison sub-module comparing the feature information with the reference information, and producing the first startup signal and the second startup signal if the feature information matches the reference information.

3. The mobile communication device of claim 2, wherein the reference information is selected from the group consisting of an international mobile subscriber identification number and an international mobile equipment identity.

4. The mobile communication device of claim 1, wherein when the positioning module receives the second startup signal, the positioning module sends a positioning request to a global positioning system (GPS) or a global navigation satellite systems (GNSS), and produces the location information according to positioning signals fed back from the GPS or the GNSS.

5. A method for reporting location of a mobile communication device, the method comprising:
providing a mobile communication device, the mobile communication device including a communication module, a self-startup control module, a positioning module, and a central processing module;
discontinuing the power from a power source to the mobile communication device when the power management module receives a power-off signal, except for the communication module and the self-startup control module receiving radio signals via the communication module;
analyzing the radio signals and obtaining feature information of the radio signals;
comparing the feature information with reference information stored in the self-startup control module;
distributing power from the power source to the positioning module and the central processing module if the feature information matches the reference information;
providing location information via the positioning module; and
controlling the communication module to send the location information to a mobile service center via the central processing module.

6. The method of claim 5, wherein the reference information is selected from the group consisting of an international mobile subscriber identification number and an international mobile equipment identity.

7. The method of claim 5, wherein providing location information at the positioning module comprises:
sending a positioning request to a global positioning system (GPS) or a global navigation satellite systems (GNSS);
producing location information according to positioning signals fed back by the GPS or the GNSS.
